(19) United States
(12) Patent Application Publication
(10) Pub. No.: US 2003/0226068 A1
(43) Pub. Date: Dec. 4, 2003

(54) Run time method of control system interface design and device control

(76) Inventor: John Scott Rule, Big Bear Lake, CA (US)

Correspondence Address: John S. Rule, P.O. Box 130658, Big Bear Lake, CA, 92315, US

(21) Appl. No.: 10/156,524

(22) Filed: May 28, 2002

(51) Int. Cl. H02H 3/05; G06F 9/44

(52) U.S. Cl. 714/46; 717/125

(57) ABSTRACT

This specification for a ‘run time’ software engine provides a ‘new’ method for control systems interface creation and execution. This custom engine has an integrated object designing method which gives a ‘designer’ or ‘user’ the ability to manipulate graphical and functional properties of each control ‘object’ at ‘run time’ . . . there is no compiling, re-compiling, or separate application that is required. This method also allows the created object to be tested at ‘run time’ using an integrated ‘debugger’ and parameter parsing ‘software logic engine’ without switching into a ‘mode’. The software logic engine, software graphics engine, software editor, and software debugger are combined in one software engine . . . this is what allows for this unique method of ‘run time’ editing and debugging without the need to compile, edit, test in any external application(s), upload to any external hardware, or to switch into a special ‘mode’ that will terminate ‘run time’ execution.

### BACKGROUND OF INVENTION

Similar in nature to other control systems editors and compilers:

a) VTPro-E from Crestron electronics: VisionTools™Pro-e (or VT Pro-e) is a Windows-based software program that enables you to design, create and load touch screen layouts for all Crestron touch panels and SmartTouch systems. The VT Pro-e interface is similar to that of most other Windows-based programs: a menu bar is displayed across the top of the screen selecting a menu item either performs an action or displays a submenu or dialog box. Many other Windows-based programs, VT Pro-e provides toolbars for quick access to commonly used commands. The toolbars are dockable, which means they can be positioned in various places on the screen by clicking and dragging.

b) SIMPL for Windows from Crestron: SIMPL Windows is Crestron's Windows-based development environment for programming Crestron control systems. Using a graphical interface with extensive right-click functionality and drag-and-drop capabilities, SIMPL Windows provides the link between Crestron systems hardware, touch panels, and the world of equipment to be controlled.

c) TPDesign from AMX corporation: TPDesign3 is a 32-bit Windows® application that enables you to create touch panel pages in minutes. You can use TPDesign3 to import fonts, bitmaps, and icons for use in your file pages and then download the newly created files to either a touch panel or the Internet. TPDesign3 provides point-and-click touch panel programming and page printing. You can program panels through the Central Controller's program port via AXlink or directly through the touch panel's onboard RS-232 DB-9 port.

d) NetLinx Studio from AMX: NetLinx is the second generation of the Axcess® programming language and is a superset of the Axcess language with extensions for additional data types, new event handlers, structure multi-dimensional arrays, and other features. This document assumes that you are familiar Axcess; the focus is on the new language elements and how they extend the functionality of existing language.

Problems with current methods of control systems interface design: a) You must use separate software for creating/editing the user interface. b) You must use a separate program for code creation (the ‘logic’). c) You must compile the object ‘code’. d) You must upload the compiled code to a separate hardware device. e) You must upload the compiled user interface code to another hardware device. e) You must be connected to the hardware device to ‘debug’ the code. f) You must use the Microsoft ‘Windows’ operating system.

### SUMMARY OF INVENTION

This ‘new’ software engine and it's methods address all of the problems mentioned in “Problems with the “current” methods of control systems interface design:” by providing an integrated software engine, and providing ‘cross platform’ capability for that engine.

Field of Endeavor: Consumer and commercial integrated systems control consisting of audio visual equipment, environmental equipment, and forthcoming internet appliances.

### BRIEF DESCRIPTION OF DRAWINGS

The included graphics are an example of a ‘run time’ software engine, and are included to help you understand the concept, but the ‘method’ is independent of this specific software. The software for reproducing this ‘method’ can be written according to the specifications outlined in “Detailed Description”. This specific software is the Intellectual Property of the claimant, and was designed according to these specifications for a run time control systems interface engine with integrated editor method.

FIG. 1.1 The Main Editor of a ‘Run Time’ environment for control systems interface design. The focus of creation are buttons and objects that can be activated to send control information within it's internal engine or to an external device such as a DVD or Internet device The buttons can operate while you are editing any object (including itself) without halting the running program. The parameters for each object are defined in ‘sections’ indicated by the ‘Parameters’ selection area The lower half of the Editor will change according to the parameters that are being edited.

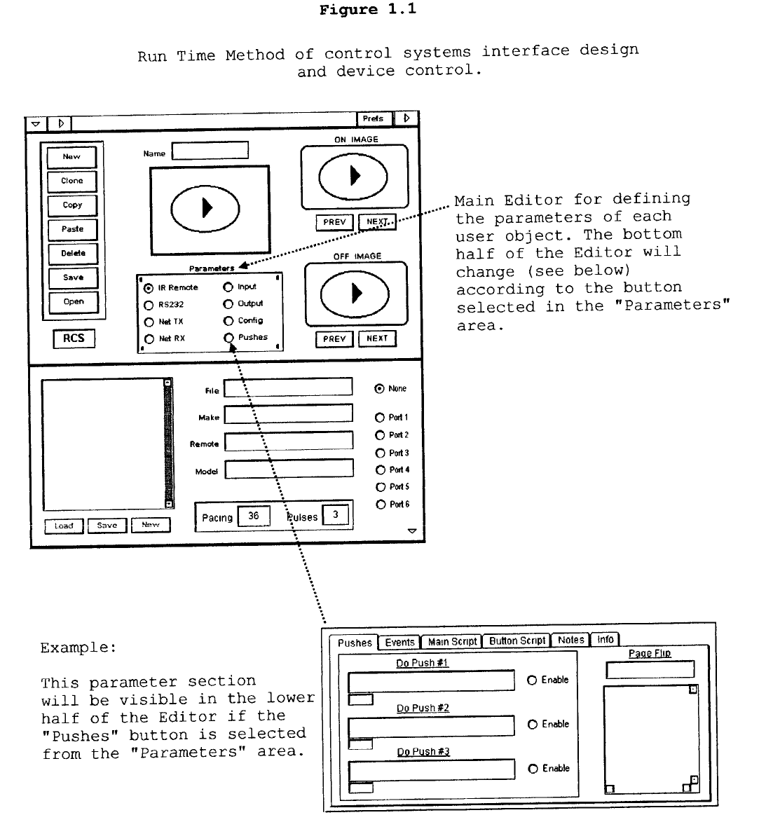

FIG. 1.2 The Info Palette provides ‘run time’ information on each object as it is pressed. The parameters can be changed at any time, and there is no need to recompile to affect changes.

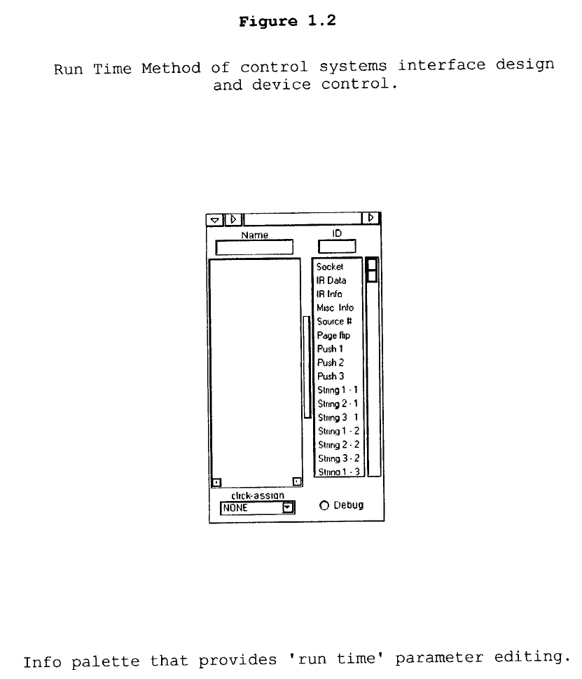

FIG. 1.3 The Parameters Palette. Like most interface design environments, tools are required to change the characteristics of an object. The standard editing tools are included, and the effects are immediate within the ‘run time’ environment. No external editor is required, and the editing tools are accessible within each control systems interface application.

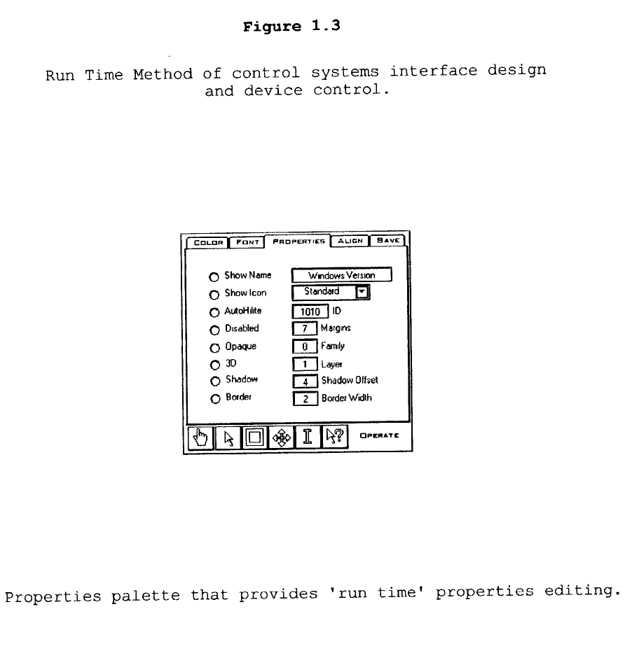

FIG. 1.4 The Control System Interface. This is one page of the ‘finished product’ of the Editor and it's palettes. The Editor and it's palettes can be hidden now, and the user interface becomes the operational environment. Because you are creating this interface at ‘run time’, you can test any object for proper functionality or errors without compiling or uploading because you are within the logic engine. Full functionality is available while you are creating this interface, and the Editor and it's palettes can be accessed at anytime for further changes.

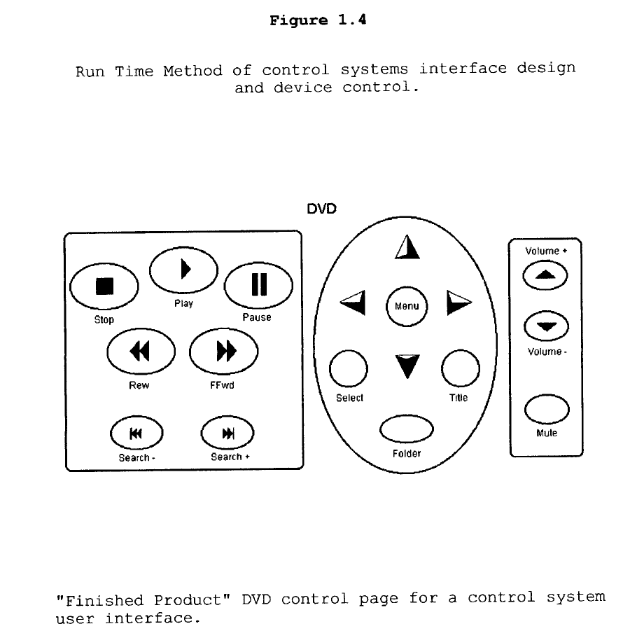

### DETAILED DESCRIPTION

a) This ‘run time’ software engine runs on most personal computing devices consisting of (but not limited to) Intel, AMD, IBM, and Motorola microprocessors. b) The software engine is compatible with most operating systems (OS) consisting of (but not limited to) The Windows OS, the Macintosh OS, the Linux OS, and the Unix OS. c) The software engine provides editing tools for creating and manipulating objects for controlling devices such as buttons, fields, and graphics without the need for an external editing environment, and without the need for halting program execution. d) There is no compiling or re-compiling to affect changes. e) Each object has the capability to ‘activate’ logic in such a manner that will allow real time manipulation of variables and objects, including objects on other devices. f) These parameters define the unique function of the object when it is activated by a ‘pressed’, ‘released’, ‘double-pressed’, or ‘held’ state. g) All of the parameters are easily accessible at ‘run time’, and can be modified at ‘run time’ with no re-compiling, and without adversely affecting program execution. h) The ‘logic’ engine, graphics engine, and debugger are integrated into one software engine. i) This engine is not dependent on any external device (software or hardware) to function, other than the hardware ‘it’ is running on. j) The debugger acts independently of the equipment device or software device being controlled.—k) The objects parameters and code are embedded into the object itself, allowing portability and further ‘run time’ editing.

In comparison, any existing interface design program is separate from the eventual engine that it's created file will ‘run’ in. An example would be a web browser that is displaying a user interface (web page) that was designed in another application. This ‘new’ method combines the two, allowing any ‘designer’ or ‘user’ access to editing tools while the software engine is interpreting the interface at ‘run time’. Any aspect of a created object can be changed during run time, including the objects embedded ‘code’. Also, most interpreting ‘engines’ require you to make changes in an external editor, or require you to switch into a ‘mode’ that either halts program execution, or adversely affects program execution for this change. You are usually required to recompile the entire program to implement the changes, and possibly upload these changes to an external device. This ‘new’ software engine and it's methods do not have any of these requirements.

In another comparison, existing integrated systems programming tools (see ‘Background of Invention’) require you to be connected to the controlled hardware to perform ‘debugging’ of the program code. This connection consists of a computer running separate editing software, and a communication ‘link’ between the computer and the hardware device to be controlled. You are also required to compile and upload this program to the hardware device for testing and use. In this ‘new’ engine, there is no uploading or compiling, and you are not required to be connected to any equipment for debugging.

1. The ‘run time’ software engine method for control systems interface design and device control is written solely by the claimant. The specifications for this engine are listed in ‘Detailed Description’. This ‘run time’ control engine does not require compilation or re-compilation to affect changes on objects created, and does not require external hardware to be attached for ‘debugging’ the program.

2. A programming method for creating and executing device control interfaces for use on a personal computer or wireless computing device in a custom software engine with an integrated ‘run time’ editor and debugger.

3. A complete, self-contained environment for the creation and execution of custom control system interfaces, with each object having it's parameters and code embedded into the object itself for complete portability, and further ‘run time’ editing.
